(19) United States
(12) Patent Application Publication
(10) Pub. No.: US 2008/0297461 A1
(43) Pub. Date: Dec. 4, 2008

(54) DRIVING APPARATUS FOR DISPLAYER AND METHEOD THEREOF

(75) Inventors: Ming-Tan Hsu, Miaoli County (TW); Jung-Chieh Cheng, Changhua County (TW); Tien-Chu Hsu, Kaohsiung City (TW); Szu-Fen Chen, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 11/834,698

(22) Filed: Aug. 7, 2007

(30) Foreign Application Priority Data
May 31, 2007 (TW) 96119572

(51) Int. Cl. G09G 3/36

(52) U.S. Cl. 345/102

(57) ABSTRACT

A driving apparatus for a displayer and a method thereof are provided. The driving apparatus includes an image processing unit, a timing controller, and a backlight controller. The image processing unit divides a frame period into an image period and a dark state period. During the dark state period, black (or gray) insertion is performed to an image with a black (or gray) frame through a scan backlight technique. During the image period, the image data is displayed through a dynamic backlight technique. Thereby, the contrast of the displayer is improved and the power consumption thereof is reduced.

### CROSS-REFERENCE TO RELATED APPLICATION

This application claims the priority benefit of Taiwan application serial no. 96119572, filed May 31, 2007. All disclosure of the Taiwan application is incorporated herein by reference.

### BACKGROUND OF THE INVENTION

1. Field of the Invention

The present invention generally relates to a driving apparatus for a displayer and a method thereof, and more particularly to a driving apparatus for image black/gray insertion and a method thereof.

2. Description of Related Art

Among consumer electronic products, liquid crystal display (LCD) displayer, especially LCD television, is usually used for displaying dynamic images. However, because a hold-type light emitting mode is adopted and the response speed of liquid crystal is very slow, edge blurs may be produced in the dynamic images displayed by a LCD due to the integration effect of human eyes.

Conventionally, overdriving techniques and black frame insertion (BFI or BI) are widely used for improving the display quality of dynamic images. With the black frame insertion technique, the black frames can be inverted with black data or dynamic backlight control (DBC), wherein black data insertion is to write black image data into the display panel by using a source driver, and the dynamic backlight control is to achieve black insertion effect through the on/off of a backlight. However, the brightness/contrast of the image will be reduced and the power of the back light will be almost wasted during a dark state period if only black data insertion is adopted; and darker image will not be produced due to light leakage of the liquid crystal if only the dynamic backlight control is adopted.

In addition, according to the conventional technique, black image data is usually written in image times of a constant ratio or at image intervals without considering the brightness of the displayed image. Thus, if the image data can be first analyzed and corrected and the on/off time of the backlight can be then adjusted according with black data insertion and dynamic backlight control, the moving picture response time (MPRT) of the display panel can be improved and the power consumption of the displayer can be greatly reduced.

### SUMMARY OF THE INVENTION

Accordingly, the present invention is directed to a driving apparatus for a displayer and a method thereof, wherein data black/gray insertion and dynamic backlight techniques are both used for performing image black/gray insertion, and a control signal of the dynamic backlight is adjusted according to an image data analysis result, so that the display quality and contrast of a liquid crystal display (LCD) panel can be improved and the power consumption thereof can be reduced.

The present invention is directed to a display driving apparatus and a method thereof, wherein the frequency of an image data is multiplied and a frame period is then divided into an image period and a dark state period respectively for displaying the image data and a gray scale image data. According to the present invention, during the image period, the on/off time of the backlight is adjusted according to the image data, and during the dark state period, scan backlight and data black/gray insertion are adopted for improving the performance of black/gray insertion and the contrast of the image.

The present invention provides a driving apparatus for driving a displayer to display an image data, wherein the image data includes at least one frame period. The driving apparatus includes an image processing unit, a timing controller, and a backlight controller. The image processing unit analyzes and adjusts the image data, and divides a frame period into an image period and a dark state period. During the dark state period, the timing controller outputs a gray scale image data, and the backlight controller sequentially adjusts the brightness of a plurality of backlight sources or turns off the backlight sources according to the scanning manner of the timing controller.

According to an embodiment of the present invention, the image processing unit includes a frequency multiplication unit and an image calculation unit. The frequency multiplication unit adjusts the operation period of the image data, and the image calculation unit outputs a dynamic backlight control signal and a display data according to the adjusted image data. The timing controller outputs a gray scale image data during the dark state period according to the display data, and the backlight controller adjusts the brightness of the backlight sources according to the dynamic backlight control signal.

According to an embodiment of the present invention, the timing controller outputs the adjusted image data during the image period, and the backlight controller sequentially adjusts the brightness of the backlight sources during an image adjusting period according to the adjusted image data and the scanning manner of the timing controller.

According to an embodiment of the present invention, the timing controller outputs the adjusted image data during the image period, and the backlight controller sequentially turns on the backlight sources and adjusts the brightness thereof according to the adjusted image data. The backlight controller sequentially turns off the backlight sources during the dark state period according to the scanning manner of the timing controller.

According to an embodiment of the present invention, the backlight controller includes a pulse width modulation (PWM) generating circuit and a backlight driving circuit, wherein the PWM generating circuit generates a PWM signal, and the backlight driving circuit adjusts the brightness or on/off time of the backlight sources according to the PWM signal.

According to an embodiment of the present invention, the gray scale image data includes a black image data or a gray image data.

The present invention further provides a driving method for driving a displayer to display an image data, wherein the image data includes at least one frame period. The driving method includes following steps. First, the image data is received. Then the operation period of the image data is adjusted, and the frame period is divided into an image period and a dark state period. Next, a gray scale image data is output during the dark state period, and during the dark state period, the brightness of a plurality of backlight sources is sequentially adjusted according to the scanning manner of the display.

According to an embodiment of the present invention, forgoing driving method further includes following steps in the step of outputting the gray scale image data during the dark state period. The adjusted image data is output during the image period according to a display data, and the brightness or on/off time of the backlight sources is adjusted according to a dynamic backlight control signal. The other details of foregoing driving method will be described with reference to embodiments of the present invention therefore will not be described herein.

In the present invention, black/gray data insertion and dynamic backlight control are both adopted and the brightness of backlight sources is dynamically adjusted according to the analysis result of the image data, thus, the moving picture response time (MPRT) and contrast of the display panel can be improved and the power consumption thereof can be reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic block diagram of a display driving apparatus according to an embodiment of the present invention.

FIG. 1B is a disposition diagram of cold cathode fluorescent lamps (CCFLs) according to an embodiment of the present invention.

FIG. 1C is a disposition diagram of light emitting diodes (LEDs) according to an embodiment of the present invention.

FIG. 2 is an operation timing diagram of the driving apparatus in FIG. 1A.

FIG. 3 is a diagram illustrating the scanning manner of the driving apparatus in FIG. 1A.

FIG. 4 is a diagram illustrating the scanning manner of a timing controller according to another embodiment of the present invention.

FIG. 5 is a diagram illustrating the data black/gray insertion and backlight timing scan according to another embodiment of the present invention.

FIG. 6 is a scan timing diagram according to another embodiment of the present invention.

FIG. 7 is a scan timing diagram according to another embodiment of the present invention.

FIG. 8 is a flow chart illustrating a display driving method according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

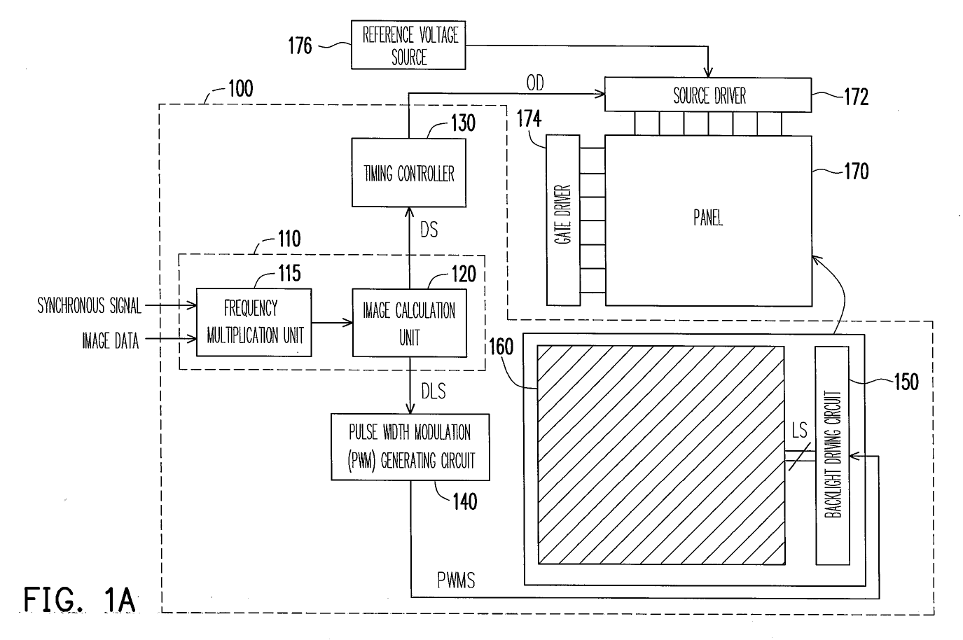

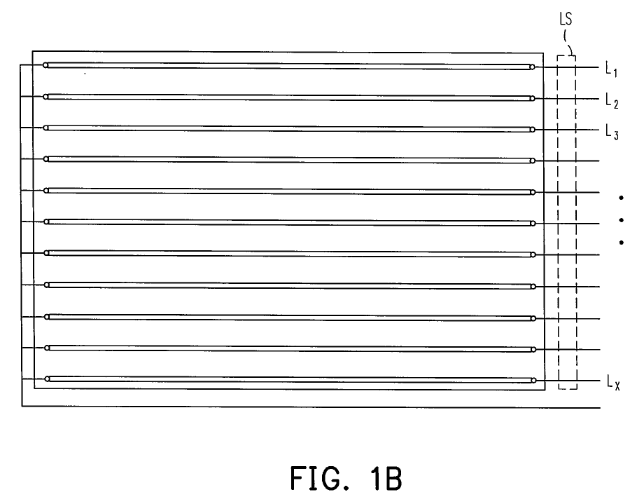

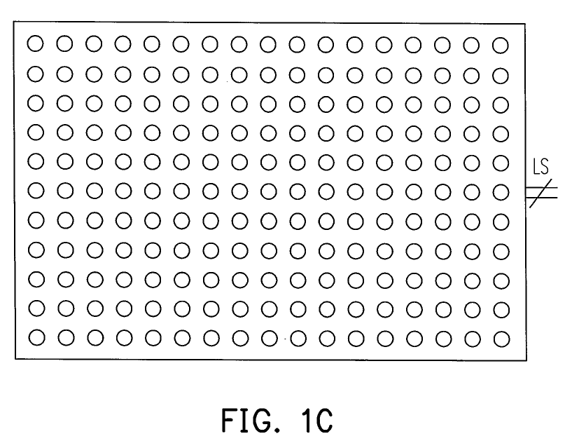

FIG. 1A is a schematic block diagram of a driving apparatus according to an embodiment of the present invention. The driving apparatus 100 includes an image processing unit 110, a timing controller 130, and a backlight controller, wherein the image processing unit 110 includes a frequency multiplication unit 115 and an image calculation unit 120, and the backlight controller includes a pulse width modulation (PWM) generating circuit 140 and a backlight driving circuit 150. The timing controller 130 controls a source driver 172 and a gate driver 174. The backlight unit 160 is controlled by the backlight driving circuit 150 and provides light sources to a panel 170, wherein the backlight unit 160 includes a plurality of backlight sources, such as cold cathode fluorescent lamps (CCFLs) or light emitted diodes (LEDs), and the on/off time of these backlight sources are respectively controlled by a backlight control signal LS.

FIG. 1B and FIG. 1C respectively illustrate the dispositions of cold cathode fluorescent lamps (CCFLs) and light emitting diodes (LEDs) according to embodiments of the present invention. The backlight sources are disposed as shown in FIG. 1B if they are made of CCFLs. The backlight sources are disposed as shown in FIG. 1C if they are made of LEDs. However, FIG. 1B and FIG. 1C illustrate only examples of backlight dispositions according to embodiments of the present invention but not for restricting the scope of the present invention. The backlight control signal LS may include backlight control signals L₁˜L_{X} respectively corresponding to the scan areas on the panel, wherein each of the backlight control signals L₁˜L_{X} is respectively used for controlling the backlight sources within a scan area (containing a plurality of scan lines). If the backlight sources are made of CCFLs, the backlight control signals L₁˜L_{X} can be used for respectively controlling the brightness of each CCFL.

The driving apparatus 100 drives the displayer to display an image data, wherein the image data includes at least one frame period. The displayer includes a source driver 172, a gate driver 174, and a panel 170. The timing controller 130 is coupled to the image processing unit 110 for controlling the source driver 172 and the gate driver 174. The backlight controller (including a PWM generating circuit 140 and a backlight driving circuit 150) drives the backlight sources in the backlight unit 160 according to the dynamic backlight control signal DLS output by the image processing unit 110. The reference voltage source 176 provides a reference voltage to the source driver 172.

When the driving apparatus 100 receives an image data, the image processing unit 110 analyzes and adjusts the image data and then divides the frame period in the image data into an image period and a dark state period. During the dark state period, the timing controller 130 outputs a gray scale image data in order to perform black/gray data insertion to the panel 170, and the backlight controller sequentially adjusts the brightness of a plurality of backlight sources according to the scanning manner of the timing controller 130. In other words, the backlight controller sequentially performs black/gray frame insertion to the panel 170 through both scan backlight technique and black/gray data insertion. During the image period, the image data is displayed, and the on/off time of the backlight sources is adjusted according to the displayed image content through dynamic backlight technique.

In the image processing unit 110, when the frequency multiplication unit 115 receives the image data, it multiplies the frequency of the image data according to a synchronous signal, for example, it performs 60 Hz image frequency multiplication, in order to shorten the operation period of the image data. If the original frequency of the image data is 60 Hz, then the frame period required by the image data with the multiplied frequency will become half of its original frame period, and the rest time may be used for black/gray data insertion. The image calculation unit 120 divides a frame period into an image period and a dark state period. The image data is displayed during the image period, and the gray scale image data is inserted during the dark state period, so that the display effect of alternate normal images/black images is achieved. Foregoing gray scale image data includes a black image data or a gray image data, wherein the black image data is input if black image insertion is required, and the gray image data is input if gray image insertion is required.

The image calculation unit 120 outputs the dynamic backlight control signal DLS to the PWM generating circuit 140 and the display data DS to the timing controller 130 according to the image data having the multiplied frequency, wherein the display data DS includes the image period and the dark state period. Thus, corresponding black/gray data insertion is performed to the image data in each frame period, and when black/gray data insertion is performed, the backlight controller adjusts the brightness of the backlight sources according to the dynamic backlight control signal DLS in order to enhance the performance of black/gray insertion. When the image data is displayed, the backlight sources are turned on correspondingly. The PWM generating circuit 140 in the backlight controller generates a PWM signal PWMS, and the backlight driving circuit 150 adjusts the brightness or on/off time of the backlight sources according to the PWM signal PWMS.

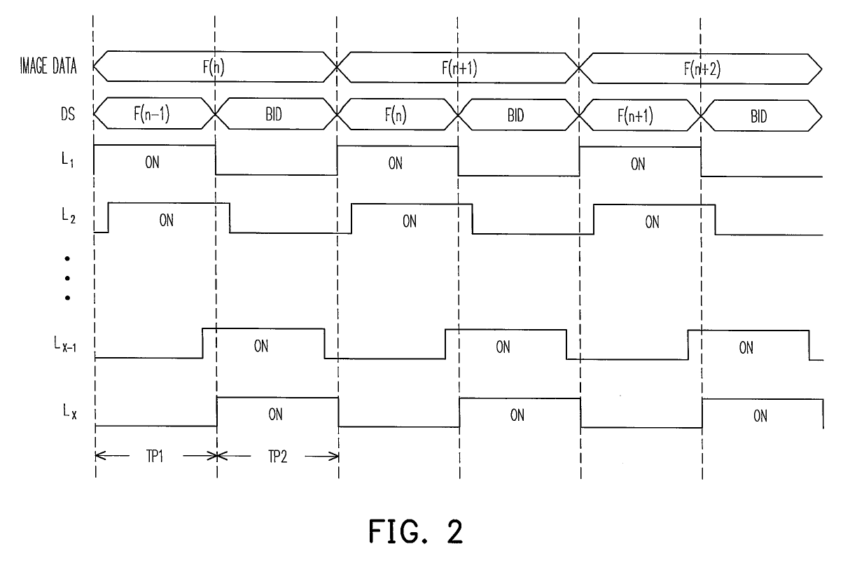

Next, the operation timing in embodiments of the present invention will be further described. FIG. 2 is an operation timing diagram of the driving apparatus in FIG. 1A. Referring to both FIG. 1A and FIG. 2, the frame data F(n)˜F(n+2) in the image data represent the image data of the n˜(n+2) frames. After the image data has been adjusted, the image calculation unit 120 inserts a gray scale image data BID into the display data DS, thus, the frame period T includes an image period TP1 and a dark state period TP2, and the image period TP1 includes the corresponding frame data F(n−1) in the adjusted image data, and the dark state period TP2 includes the gray scale image data BID. The display data DS is delayed since it is calculated from the image data. In the present embodiment, the display data DS is delayed a frame period, thus, the display data DS includes the frame data F(n−1) during the frame period T, and it includes the frame data F(n) during the next frame period.

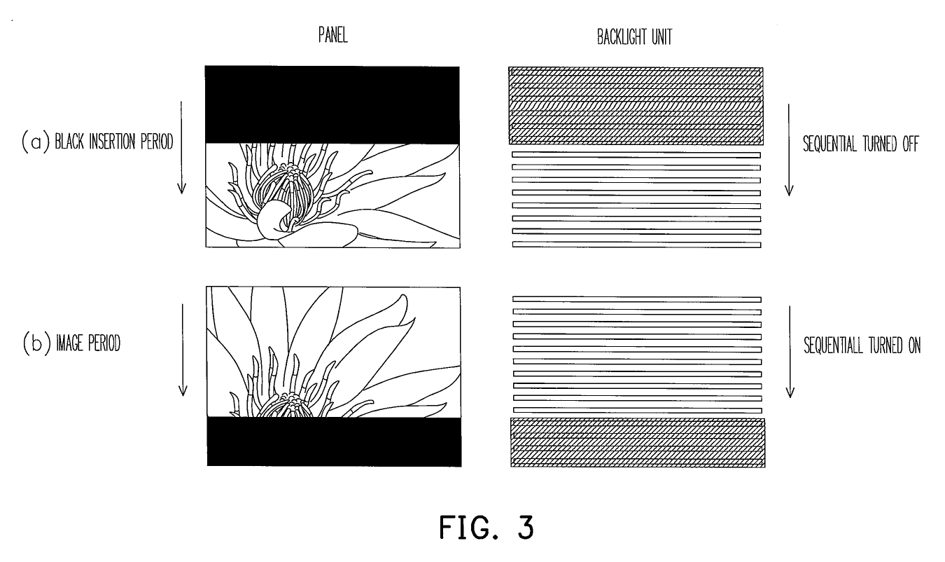

The images in the display data DS are alternate normal images and black/gray images, thus, during the image period TP1, the corresponding backlight sources are turned on sequentially according to the backlight control signals L₁˜L_{X}. During the dark state period TP2, the corresponding backlight sources are sequentially turned on/off in order to enhance the black/gray frame insertion effect. As shown in FIG. 2, when the backlight control signals L₁˜L_{X} are at logic high voltage level, the corresponding backlight sources are turned on, while when the backlight control signals L₁˜L_{X} are at logic low voltage level, the corresponding backlight sources are turned off. FIG. 3 is a diagram illustrating the scanning manner of the driving apparatus in FIG. 1A. During the dark state period, as shown in FIG. 3(a), the image in the panel starts to perform black/gray data insertion, and the backlight sources in the backlight unit are sequentially turned off according to the scanning manner of the panel. During the image period, as shown in FIG. 3(b), the image in the panel starts to update and display the image data, and the backlight sources in the backlight unit are sequentially turned on according to the scanning manner of the panel (controlled by the timing controller). In other words, when the driving apparatus 100 is displaying the image and performing black/gray frame insertion to the image, it also turns on/off the backlight sources according with the scan timing, so as to enhance the effect of the black/gray insertion.

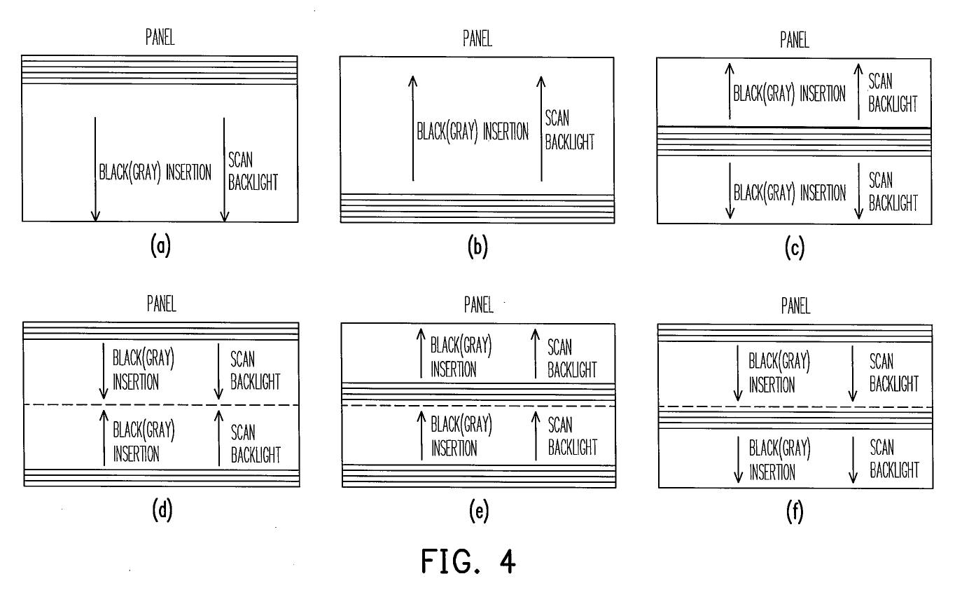

The scanning manner of the timing controller includes scanning from top to bottom, scanning from bottom to top, scanning outwards from the centre, scanning from top and bottom to the middle, or scanning by blocks. FIG. 4 is a diagram illustrating the scanning manner of a timing controller according to another embodiment of the present invention. FIG. 4(a)˜FIG. 4(f) respectively illustrate different scanning manners. FIG. 4(a) illustrates the pattern of scanning from top to bottom, wherein the scan sequence FIG. 4(b) illustrates the pattern of scanning from bottom to top. FIG. 4(c) is scanning outwards from the centre, FIG. 4(d) is scanning from top and bottom to the middle, and FIG. 4(e) and FIG. 4(f) are scanning block by block. However, the present invention is not limited by foregoing scanning manner, and other applicable scanning manners should be adopted by those having ordinary knowledge in the art based on the present disclosure, therefore will not be described herein.

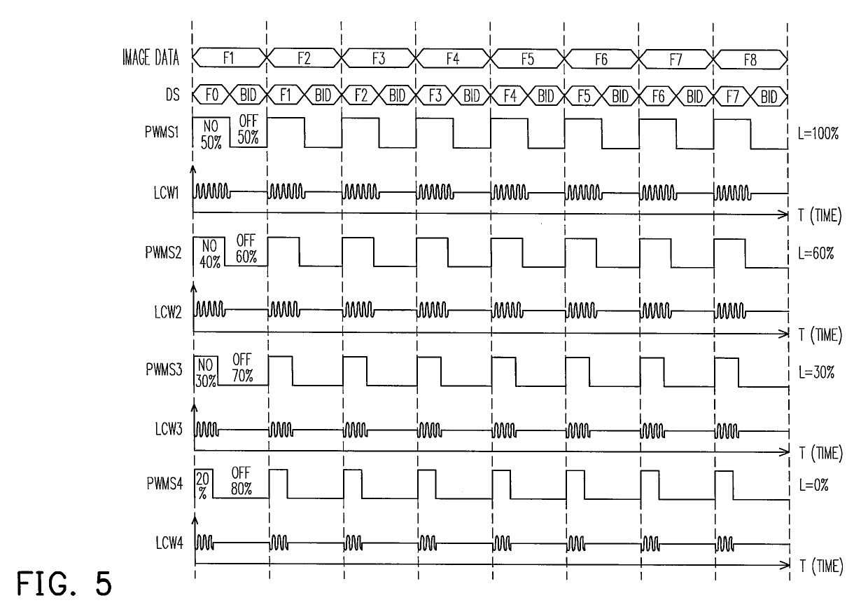

In the present embodiment, the on/off time ratio of the backlight sources is not restricted to 1:1 but can be determined according to the actual requirement. In the present embodiment, the ratio of the backlight sources within the entire frame period is determined by a coefficient L. The image calculation unit 120 adjusts the display data DS according to the coefficient L. FIG. 5 is a diagram illustrating the data black/gray insertion and backlight timing scan according to another embodiment of the present invention. In the present embodiment, the coefficient L represents the duty cycle of the PWM signal PWMS, wherein when the PWM signal PWMS is at logic low voltage level (disabled), the corresponding backlight source is turned off. When L=100%, the disabled period of the PWM signal PWMS is 50% (such as the PWM signal PWMS1), namely, the disabled period of the PWM signal PWMS is half of the frame period. When L=60%, the enabled period of the PWM signal PWMS is 40% (such as the PWM signal PWMS2). When L=30%, the disabled period of the PWM signal PWMS is 30% (such as the PWM signal PWMS3). When L=0%, the disabled period of the PWM signal PWMS is 20% (such as the PWM signal PWMS4). The relationship between the coefficient L and the PWM signals PWMS1˜4 may be determiined according to the actual requirement. The driving current waveforms LCW1˜4 of the backlight sources are determined according to the enabled periods of the PWM signals PWMS1˜4. When the PWM signal PWMS is enabled, the backlight driving circuit 150 generates a corresponding driving current waveform to drive the corresponding backlight source.

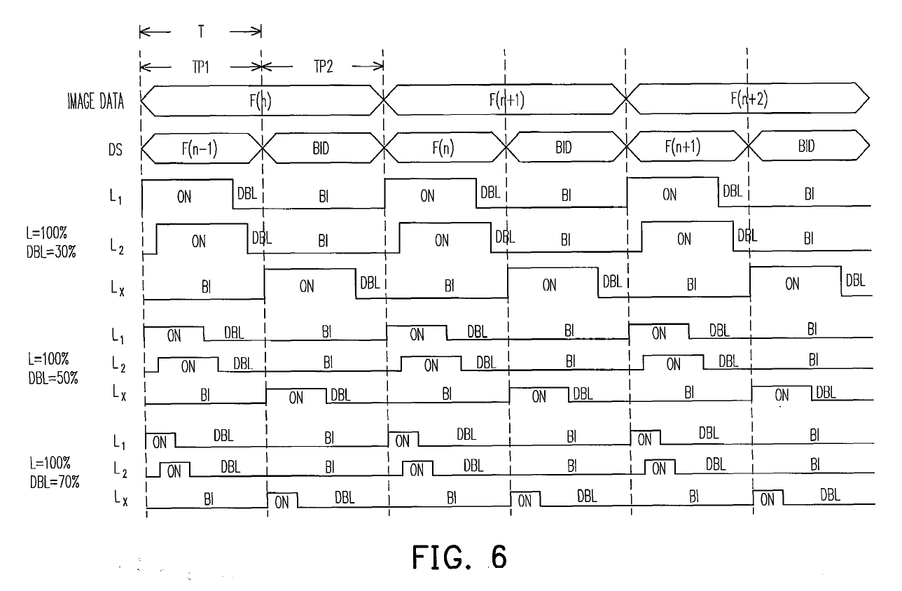

In addition, in another embodiment of the present invention, during the image period, the on/off time of the backlight sources may also be dynamically adjusted according to the displayed image data, namely, dynamic backlight technique is used for improving the contrast of the image and enhancing the effect of black/gray insertion. FIG. 6 is a scan timing diagram according to another embodiment of the present invention. For example, the frame period T includes an image period TP1 and the dark state period TP2. The off time of the backlight sources during the dark state period TP2 can be determined using the coefficient L, and the on/off time of the backlight sources during the image period TP1 can be determined through dynamic backlight ratio DBL. During the image period TP1, the on/off time of the backlight sources is determined according to the image data, wherein when the image is brighter, longer on time can be set, while when the image is darker, shorter on time can be set, so as to enhance the contrast of the image.

In FIG. 6, for example, L=100%, when the DBL=30%, the duty cycle of the PWM signal PWMS is 50%, and during the enabled period of the PWM signal PWMS, the backlight sources are turned off for 30% time. When DBL=50%, the backlight sources are turned off for 50% time during the enabled period of the PWM signal PWMS. When DBL=70%, the backlight sources are turned off for 70% time during the enabled period of the PWM signal PWMS.

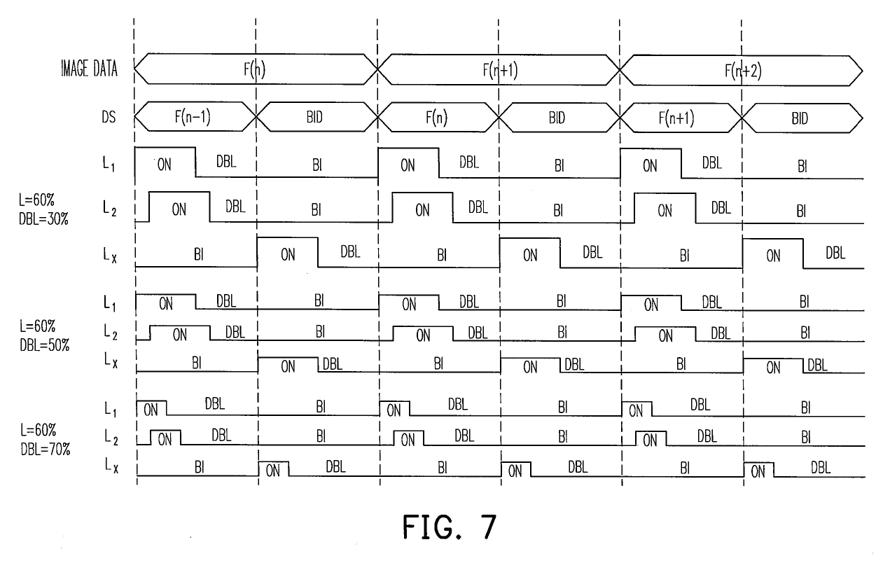

In another embodiment of the present invention, the on/off time of the backlight sources can be adjusted with different coefficient L through dynamic backlight technique. FIG. 7 is a scan timing diagram according to another embodiment of the present invention. The difference between FIG. 7 and FIG. 6 is that the coefficient L is 60%, which means the duty cycle of the PWM signal PWMS is 40%. Thus, in FIG. 7, the off time of the backlight sources are longer, and the effect of black/gray insertion is enhanced and the contrast of the image is improved by using dynamic backlight control.

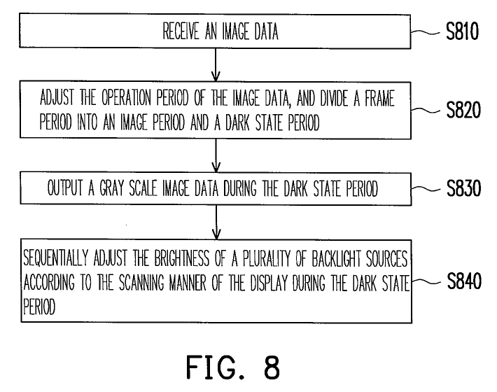

The present invention further provides a driving method suitable for driving a displayer in order to display an image data, wherein the image data includes at least one frame period. FIG. 8 is a flow chart illustrating a display driving method according to another embodiment of the present invention. In step S810, an image data is received. Then in step S820, the operation period of the image data is adjusted (for example, the frequency of the image data is multiplied), and the frame period is divided into an image period and a dark state period. Next, in step S830, a gray scale image data is output during the dark state period, and in step S840, the brightness of a plurality of backlight sources are sequentially adjusted or the backlight sources are sequentially turned off according to the scanning manner of the display during the dark state period. In other words, in foregoing steps S830 and S840, black/gray data insertion and timing scan backlight technique are both adopted and black/gray insertion is performed to an image according to the scanning manner of the display. The scanning manner of the display includes scanning from top to bottom, scanning from bottom to top, scanning outwards from the centre, scanning from top and bottom to the middle, and scanning by blocks etc. However, other scanning manner may also be adopted in the present embodiment.

In another embodiment of the present invention, in step S820, a dynamic backlight control signal and a display data are further output according to the adjusted image data, wherein the display data includes the image period and the dark state period. Step S830 further includes following steps. First, the adjusted image data is output during the image period according to the display data, and the brightness of the backlight sources is adjusted according to the dynamic backlight control signal. Step S840 further includes following steps. First, during the dark state period, the backlight sources are sequentially turned off, and during the image period, the backlight sources are sequentially turned on, and the on/off time of the backlight sources are adjusted through dynamic backlight technique.

In overview, the driving apparatus in the present invention first multiplies the frequency of an image data and then performs data black/gray insertion to the image through timing scan backlight technique. During an image period, the brightness of the image is adjusted according to the analysis result of the image data to be displayed through dynamic backlight technique, so that the contrast of the image is improved and the power consumption is reduced. In addition, the present invention may also be applied to an optically compensated bend mode liquid crystal display (OCB LCD) in order to enhance the data black/gray insertion effect with the rapid response speed of OCB liquid crystal.

According to the present invention, data black/gray insertion, dynamic backlight, and timing scan backlight techniques are adopted so that when black/gray insertion is performed to an image, darker gray scale can be achieved, and the contrast of the image can be improved and the power consumption of the backlight sources can be reduced while the image is displayed normally.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving apparatus, for driving a displayer to display an image data, the image data comprising at least one frame period, the driving apparatus comprising:.
an image processing unit, for analyzing and adjusting the image data, and the image processing unit dividing the frame period into an image period and a dark state period;
a timing controller, outputting a gray scale image data during the dark state period; and
a backlight controller, sequentially adjusting the brightness of a plurality of backlight sources according to the scanning manner of the timing controller during the dark state period.

2. The driving apparatus of claim 1, wherein the image processing unit comprises:
a frequency multiplication unit, for adjusting the operation period of the image data; and
an image calculation unit, outputting a dynamic backlight control signal and a display data according to the adjusted image data, wherein the display data comprises the image period and the dark state period,
wherein the timing controller outputs the gray scale image data according to the display data during the dark state period, and the backlight controller adjusts the brightness of the backlight sources according to the dynamic backlight control signal.

3. The driving apparatus according to claim 2, wherein the timing controller outputs the adjusted image data during the image period, and the backlight controller sequentially adjusts the brightness of the backlight sources during the image adjusting period according to the adjusted image data and the scanning manner of the timing controller.

4. The driving apparatus of claim 1, wherein the timing controller outputs the adjusted image data during the image period, and the backlight controller sequentially turns on the backlight sources and adjusts the brightness of the backlight sources according to the adjusted image data.

5. The driving apparatus of claim 1, wherein the backlight controller sequentially turns on/off the backlight sources during the dark state period according to the scanning manner of the timing controller.

6. The driving apparatus of claim 1, wherein the backlight controller comprises:
a pulse width modulation (PWM) generating circuit, for generating a PWM signal; and
a backlight driving circuit, adjusting the brightness of the backlight sources according to the PWM signal.

7. The driving apparatus of claim 1, wherein the backlight sources comprise cold cathode fluorescent lamps or light emitted diodes.

8. The driving apparatus of claim 1, wherein the scanning manner of the timing controller comprises scanning from top to bottom, scanning from bottom to top, scanning outwards from the centre, scanning from top and bottom towards the middle, or scanning by blocks.

9. The driving apparatus of claim 1, wherein the gray scale image data comprises black image data or gray image data.

10. A driving method, for driving a displayer to display an image data, the image data comprising at least one frame period, the driving method comprising:
receiving the image data;
adjusting the operation period of the image data, and dividing the frame period into an image period and a dark state period;
outputting a gray scale image data during the dark state period; and
sequentially adjusting the brightness of a plurality of backlight sources according to the scanning manner of the display during the dark state period.

11. The driving method of claim 10, wherein adjusting the image data further comprises:
outputting a dynamic backlight control signal and a display data according to the adjusted image data, wherein the display data comprises the image period and the dark state period.

12. The driving method of claim 11, wherein outputting the gray scale image data during the dark state period further comprises:
outputting the adjusted image data during the image period according to the display data; and
adjusting the brightness of the backlight sources according to the dynamic backlight control signal.

13. The driving method of claim 10, wherein the step of sequentially adjusting the brightness of the backlight sources according to the scanning manner of the display further comprises:
sequentially turning off the backlight sources during the dark state period; and
sequentially turning on the backlight sources during the image period.

14. The driving method of claim 10, wherein the scanning manner of the display comprises scanning from top to bottom, scanning from bottom to top, scanning outwards from the center, scanning from top and bottom to the middle, or scanning by blocks.

15. The driving method of claim 10, wherein the gray scale image data comprises black image data or gray image data.
